(19) United States
(12) Patent Application Publication
(10) Pub. No.: US 2006/0076165 A1
(43) Pub. Date: Apr. 13, 2006

(54) Weighing station

(76) Inventors: Antoine J. H. Winkelmolen, Shawnee, KS (US); Robert G. Jones, Dartmouth (CA); Douglas Bryan Barnett, Olathe, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/242,257

(22) Filed: Oct. 3, 2005

Related U.S. Application Data
(60) Provisional application No. 60/615,231, filed on Oct. 1, 2004.

(51) Int. Cl. G01G 19/00

(52) U.S. Cl. 177/145; 53/502

(57) ABSTRACT

The present invention is directed to a weighing station that comprises a positioning apparatus, a drive mechanism, and a scale apparatus. In one embodiment, the positioning apparatus includes a plurality of partitions that define a plurality of product compartments. The positioning apparatus further includes a guide wall located beyond the exterior end of the partitions, with the guide wall defining a loading aperture where product may be loaded into the weighing station and a discharge aperture where product is weighed and then exits the station. The drive mechanism is coupled to the positioning apparatus and is operable to move the partitions and thereby move the product compartments so that the product compartments pass the guide wall apertures. The scale apparatus is positioned at the leading edge of the discharge aperture in the guide wall and is operable to weigh product.

### CROSS REFERENCE TO RELATED APPLICATIONS

This application claims the benefit of U.S. Provisional Application No. 60/615,231 entitled “Weighing Station,” filed Oct. 1, 2004. Priority is claimed thereto pursuant to 35 U.S.C. § 119(e).

### STATEMENT REGARDING FEDERALLY SPONSORED RESEARCH AND DEVELOPMENT

None.

### BACKGROUND OF THE INVENTION

The present invention is directed to a weighing station, and, more specifically, to a weighing station that may be incorporated into an automated production line.

There are many processing applications in which a product must be weighed. For example, in a fish processing application, only fish within a specific weight range are processed together. Thus, it is necessary to separate the fish by weight before the fish may be processed. Typically, this separation occurs at a weighing station when the fish are unloaded. After weighing, the fish are placed on a conveyor belt reserved for fish within a pre-determined weight range.

The act of weighing a product typically includes placing the product in a weighing station, waiting for weighing station to provide the weight, and then moving the product to its next position. This process is time-consuming, especially if the weighing station is shared among a number of workers or if the next positions are physically distant. Consequently, workers often will simply estimate the weight of the product. Although potentially faster, this estimation practice introduces the potential for inaccuracy and does not address the inefficiency introduced by having to move products to different locations, for example to different conveyor belts, for further processing.

Thus, an automated system that efficiently and accurately weighs products in a production line is needed.

### BRIEF SUMMARY OF THE INVENTION

To overcome the above-described disadvantages, the present invention is directed to a weighing station that comprises a positioning apparatus, a drive mechanism, and a scale apparatus. In one embodiment, the positioning apparatus includes a plurality of partitions that define a plurality of product compartments. The positioning apparatus further includes a guide wall located beyond the exterior end of the partitions, with the guide wall defining a loading aperture and a discharge aperture. The drive mechanism is coupled to the positioning apparatus and is operable to move the partitions and thereby move the product compartments so that the product compartments pass the apertures in the guide wall. The scale apparatus is positioned at the leading edge of the discharge aperture in the guide wall.

In one embodiment, the positioning apparatus includes a rotatable shaft with the partitions extending outwardly from the shaft.

In another embodiment, the drive mechanism includes a motor that is coupled to a cam-follower system. The cam-follower system includes a cam coupled to a rotatable drive shaft and a cam follower is coupled to a rotatable shaft. In this embodiment, the motor rotates the drive shaft thereby causing the cam to rotate. The rotation of the cam, in turn, forces the cam follower, and the shaft coupled thereto, to rotate.

In operation, the drive mechanism causes the partitions to move. An individual product is placed through the loading aperture and into a product compartment. Next, the drive mechanism moves the partitions until the product is positioned on the scale apparatus. The scale apparatus then weighs the product. Thereafter, the drive mechanism advances the partitions causing the product to move off of the scale apparatus whereupon the product exits the weighing station through the discharge aperture.

In one embodiment, the drive mechanism includes a motor that is coupled to a cam-follower system configured to cause the partitions to move in a stepping fashion with a delay.

It is to be understood that the invention is not limited in its application to the details of construction and to the arrangements of the components set forth in the following description or illustrated in the drawings. The invention is capable of embodiments in addition to those described and of being practiced and carried out in various ways. As such, those skilled in the art will appreciate that the conception upon which this disclosure is based may readily be utilized as a basis for the designing of other structures, methods and systems for carrying out the several purposes of the present invention. Also, it is to be understood that the phraseology and terminology employed herein are for the purpose of description and should not be regarded as limiting.

### BRIEF DESCRIPTION OF THE DRAWINGS

Further features of the present invention will become apparent to those skilled in the art to which the present invention relates from reading the following description with reference to the accompanying drawings, in which:

FIG. 1 is a perspective view of a weighing station constructed according to one embodiment of the present invention and having the cover plate of the cam housing partially removed;

FIG. 2 is a front view of the weighing station of FIG. 1;

FIG. 3 is a side view of the weighing station of FIG. 2 with the cam and cam follower shown in dashed lines;

FIG. 4 is a side view of the weighing station of FIG. 2 taken along the reference line 3-3;

FIG. 5 shows the weighing station of FIG. 4 with a product in the initial position;

FIG. 6 shows the weighing station of FIG. 4 with a product in the second position;

FIG. 7 shows the weighing station of FIG. 4 with a product in the third position;

FIG. 8 shows the weighing station of FIG. 4 with a product in the fourth position;

FIG. 9 shows the weighing station of FIG. 4 in operation with product in three positions;

FIG. 10 shows the weighing station of FIG. 4 after further rotation; and

### DETAILED DESCRIPTION OF THE INVENTION

The present invention includes an automated weighing station for a processing line that is efficient, reliable, and accurate. The weighting station automatically and accurately weighs a product and then uses that weight to assist in directing the product along its appropriate path. The invention will now be described with reference to the drawing figures. For purposes of clarity in illustrating the characteristics of the present invention, proportional relationships of the elements have not necessarily been maintained in the figures.

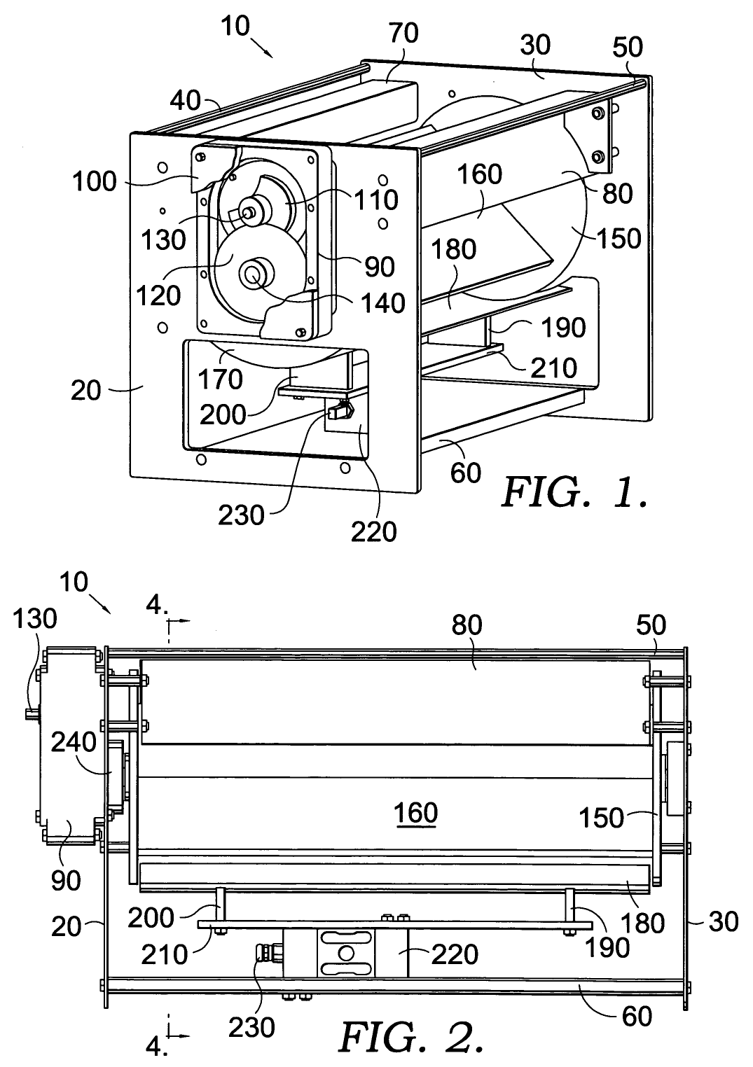

A weighing station 10 according to one embodiment of the present invention is shown in FIGS. 1 and 2. The weighing station 10 is contained within a frame that includes a first side wall 20 and a second side wall 30. It should be understood that the present invention is not limited to the particular side wall shapes shown in the figures. Two rods 40, 50 extend between and separate the two side walls 20, 30. The two rods 40, 50 are positioned at the upper corners of the side walls 20, 30. A plate 60 also extends between and separates the side walls 20, 30. The plate 60 is located near the lower edge of the side walls 20, 30. The weighing station 10 also includes a guide wall comprised of a back guide wall element 70 and a front guide wall element 80. The guide wall elements 70, 80 also extend between the side walls 20, 30.

A cam housing is coupled to the outside of the first side wall 20 and includes a housing body 90 covered by a face plate 100. A cam 110 is located inside of the housing body 90. The cam 100 is coupled to a drive shaft 130 that extends through the face plate 100. It should be understood that a motor or other drive source which are not shown explicitly in the drawings is coupled to the drive shaft 130. Operation of the motor or other drive source causes the drive shaft 130 to rotate.

A cam follower 120 is also located inside of the housing body 90. The cam follower 120 is coupled to a shaft 140. The shaft 140 extends through the cam housing 90 and through the first side wall 20. The shaft 140 continues through a bearing housing 240 and across to a second bearing housing 240 located on the second side wall 30.

A first plate 170 extends radially outward from the shaft 140 from a position near the bearing housing 240 on the first side plate 20 and a second plate 150 extends radially outward from the shaft 140 from a position near the bearing housing 240 on the second side plate 30. A number of partitions 160 extend from the shaft 140 and extend between the two plates 150, 170. The partitions define a plurality of product compartments. The product compartments are also bounded in part by the guide wall elements 70, 80 and the plates 150, 170. In this embodiment, the shaft 140, the partitions 160, the guide wall elements 70, 80, and the plates 150, 170 together comprise a positioning apparatus.

A scale apparatus is positioned below the positioning apparatus and is generally operable to weigh a product. Additionally, the scale apparatus may store and/or record the product weight and communicate this information to some other device such as a computer, controller, or other processing component (not shown). The scale apparatus includes a load plate 180 that is supported by two support elements 190, 200. A base plate 210 extends between the support elements 190, 200 and is coupled to a load cell 220. A connector 230 extends out of the load cell 220 to provide a route for the load cell to communicate with the computer, controller, or other processing component (not shown). In some embodiments, as should be understood by those in the art, the scale apparatus may include a proximity detector or an infrared light source and detector to trigger its operation.

As can be seen in FIG. 4, the guide wall elements 70, 80 define two apertures. Specifically, at the top of this embodiment of the present invention, the guide wall elements 70, 80 define a loading aperture through which a product may enter the weighing station 10. A discharge aperture is defined by the guide wall elements 70, 80 at bottom and to one side of the weighing station. The load plate 180 is positioned so that it extends from one edge and then partially across the discharge aperture.

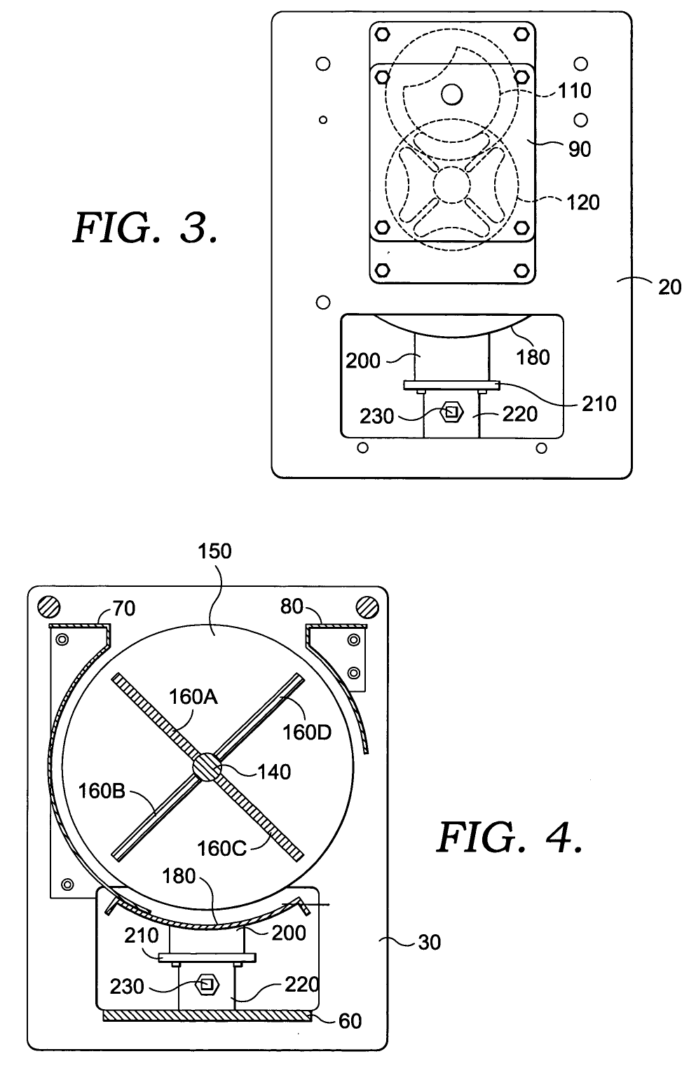

The specific shapes of the cam 110 and the cam follower 120 for this embodiment of the present invention may be seen in FIG. 3. In this embodiment, the cam 110 has a generally circular shape except that a segment is removed. The cam follower 120 has four curved sections that generally form an “X” shape. Four partitions 160A-D (FIG. 4) are coupled to the cam follower 120 between the curved sections. The curved sections of the cam follower 120 correspond to the arc of the cam 110. The cam 110 and cam follower 120 are positioned so that the outer circumference of the cam 110 will be in contact with the outer surface of the cam follower 120 sections as the two rotate. It shall be understood, of course, that rotation of the cam 110 will cause the cam follower 120 to rotate in the opposite direction.

It will be understood that the present invention is not limited to the specific shapes shown for the cam and cam follower and that other shapes will suffice. For example, in one embodiment, the cam follower includes more than four curved sections.

Additionally, it should be understood that the drive mechanism is not limited to a motor coupled to a cam-follower system although this configuration provides for accurate, repeatable, and well-defined movement. For example, in one embodiment, the drive mechanism includes a stepping motor that couples directly to the shaft 140.

In operation, the motor or other drive source causes shaft 130 to rotate. The rotation of drive shaft 130 causes the cam 110 and consequently the cam follower 120 to rotate. As should be understood by those in the field, the particular shapes of the cam 110 and the cam follower 120 in the specific embodiment of the present invention shown in the figures cause a stepping action. That is, as the cam 110 rotates through a full revolution, it moves one of the curved sections of the cam follower 120 to move 90 degrees. The cam follower 120 will not move, that is there will be a delay period, when the missing section of the cam 110 rotates past the cam follower 120. The rotation of the cam follower 120 causes the shaft 140 and the components coupled to the shaft 140, that is the side plates 150, 170 and the partitions 160A-D, to rotate.

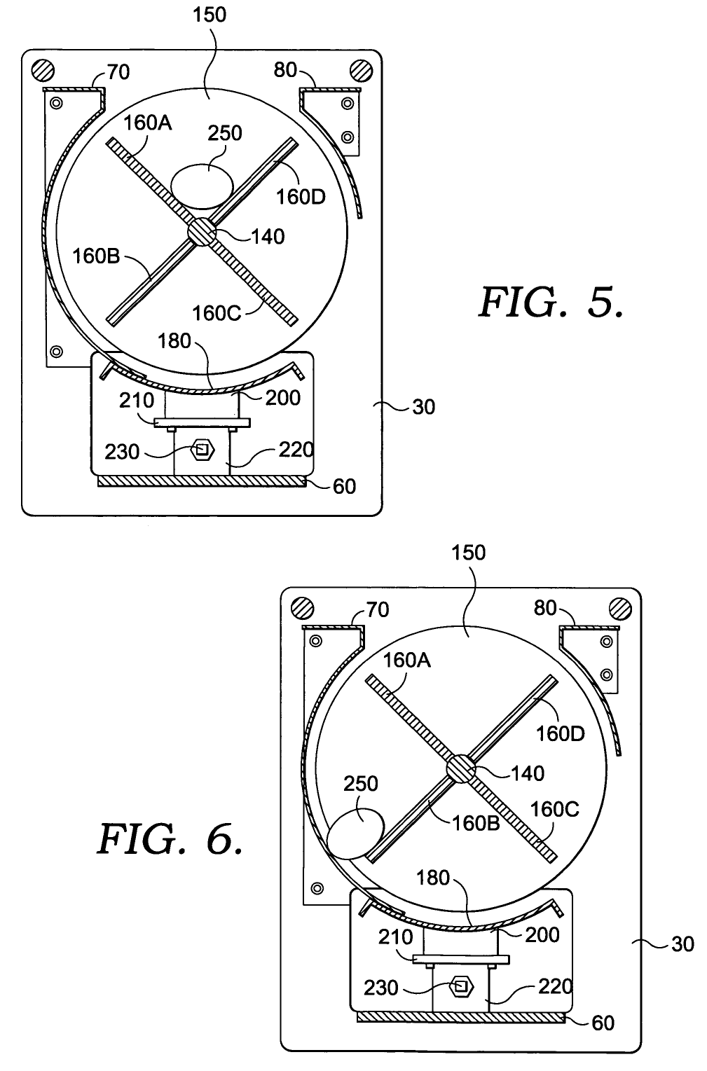

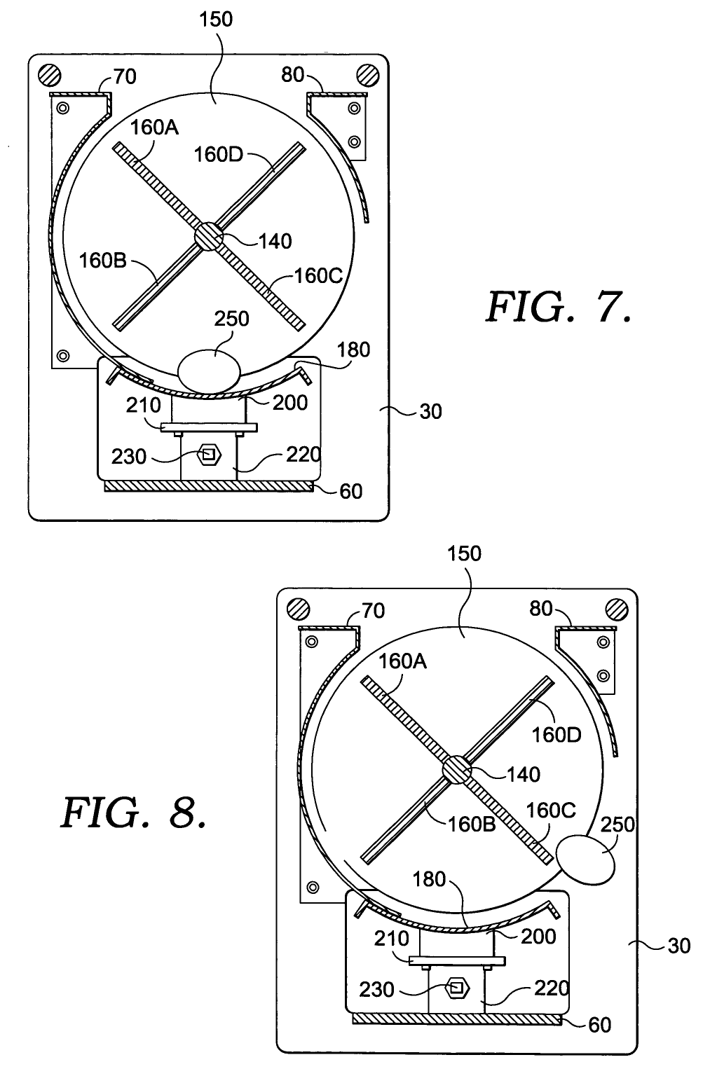

With reference to FIG. 5, in this embodiment, the motor or other drive source rotate drive shaft 130 in a clockwise direction, which causes the shaft 140 and the components coupled to the shaft 140 to rotate in a counterclockwise direction. A product 250 (such as a fish) is placed through the loading aperture and into a product compartment defined by two partitions 160A and 160D. With the first full rotation of the cam 110, the product compartment rotates 90 degrees counterclockwise as shown in FIG. 6 and the product 250 falls toward the bottom of the product compartment due to gravity. Upon the next full rotation of the cam 110, the product compartment will rotate another 90 degrees and the product 250 will come to rest on the load plate 180, as shown in FIG. 7. At this point, the product's weight is measured by the scale apparatus which then communicates that weight to the computer, controller or other processing component coupled to the scale apparatus. With the next full rotation of the cam 110, the product compartment will rotate another 90 degrees and the product 250 will be moved into a position where it will fall from the weighing station as shown in FIG. 8.

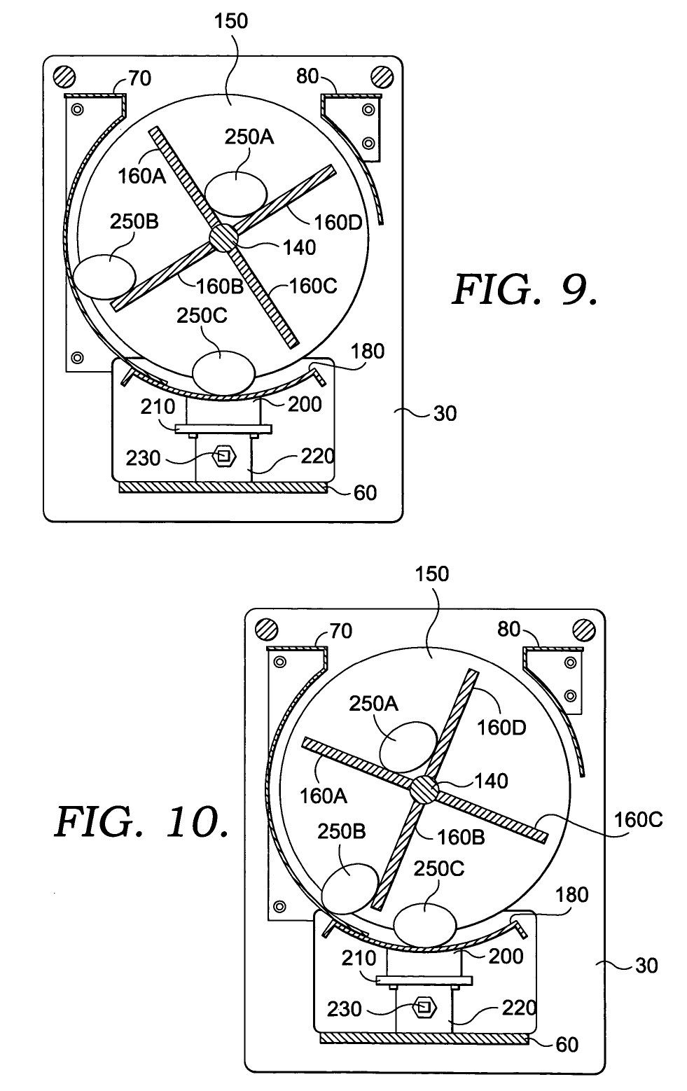

FIGS. 9 and 10 show the operation of this embodiment of the present invention with a product 250A-C in three of the product compartments. More particularly, in FIG. 9, a first product 250A has recently entered the weighing station and is positioned in a first product compartment; a second product 250B is positioned in a second product compartment (due to gravity, this product 250B has fallen into contact with the guide wall 70); and a third product 250C is positioned on the load plate 180. As seen in FIG. 10, when the cam 110 rotates causing the cam follower 120 to rotate the shaft 140 and the components coupled to the shaft 140, the front side of partition 160B will impact the product 250C on the load plate 180 and force that product 250C off of the load plate 180. Thereafter, the product 250B following in the second product compartment, which is positioned against the back side of partition 160B, will fall forward until it is located on the load plate 180. In due course, the product 250C will fall through the discharge aperture to a conveyor apparatus or another processing device.

Having described the invention, it should be apparent that the invention is both efficient and reliable. Moreover, the weighing station described above includes novel features and/or capabilities not present in the currently available systems. From the above description of preferred embodiments of the invention, those skilled in the art will perceive improvements, changes and modifications. Such improvements, changes and modifications within the skill of the art are intended to be covered by the appended claims.

Having described at least one embodiment of the invention, what is claimed is:

1. A weighing station for weighing product, the station comprising:
a positioning apparatus, the positioning apparatus having a plurality of partitions that define a plurality of product compartments, the positioning apparatus further having a guide wall located beyond the exterior end of the partitions, the guide wall defining a loading aperture and a discharge aperture;
a drive mechanism coupled to the positioning apparatus and operable to cause the partitions to move so that the product compartments pass the apertures in the guide wall; and
a scale apparatus, the scale apparatus positioned below the discharge aperture and operable to weigh product.

2. The weighing station according to claim 1 wherein the positioning apparatus includes a rotatable shaft with the partitions extending outwardly from the shaft toward the guide wall.

3. The weighing station according to claim 1 wherein the guide wall is comprised of a front guide wall element and a second guide wall element.

4. The weighing station according to claim 1 wherein there are four partitions.

5. The weighing station according to claim 1 wherein the drive mechanism includes a motor that is coupled to a cam-follower system with the cam-follower system coupled to the positioning system.

6. The weighing station according to claim 4 wherein the cam-follower system is configured to cause the positioning system to move in a stepping fashion.

7. The weighing station according to claim 5 wherein the cam-follower system is configured to cause the positioning system to step through four positions.

8. The weighing station according to claim 6 wherein the cam-follower system is further configured to cause the positioning system to delay between stepping movements.

9. The weighing station according to claim 1 wherein the drive mechanism includes a stepping motor coupled to the positioning apparatus.

10. The weighing station according to claim 1 wherein the scale apparatus is operable to communicate product weight to a processing component.

11. A weighing system for weighing product in an automated processing application, the system comprising:
a weighing station comprising a positioning apparatus, the positioning apparatus having a plurality of partitions that define a plurality of product compartments, the positioning apparatus further having a guide wall located beyond the exterior end of the partitions, the guide wall defining a loading aperture and a discharge aperture; a drive control mechanism coupled to the positioning apparatus and operable to cause the partitions to move so that the product compartments pass the apertures in the guide wall; and a scale apparatus, the scale apparatus positioned below the discharge aperture and operable to weigh product;
a motor coupled to the drive control mechanism; and
a processing component in electrical communication with the scale apparatus.

12. The weighing system according to claim 11 wherein the positioning apparatus includes a rotatable shaft with the partitions extending outwardly from the shaft toward the guide wall.

13. The weighing system according to claim 11 wherein the guide wall is comprised of a front guide wall element and a second guide wall element.

14. The weighing system according to claim 11 wherein there are four partitions.

15. The weighing system according to claim 11 wherein the drive control mechanism includes a cam-follower system.

16. The weighing system according to claim 15 wherein the cam-follower system is configured to cause the positioning system to move in a stepping fashion.

17. The weighing system according to claim 16 wherein the cam-follower system is configured to cause the positioning system to step through four positions.

18. The weighing system according to claim 16 wherein the cam-follower system is further configured to cause the positioning system to delay between stepping movements.

19. The weighing system according to claim 11 wherein the scale apparatus includes a connector and the scale apparatus is coupled to the processing component through the connector.
